(19) United States
(12) Patent Application Publication
(10) Pub. No.: US 2012/0197746 A1
(43) Pub. Date: Aug. 2, 2012

(54) Virtual Ticket Line in a Computer System

(76) Inventor: Scott C. Harris, Rancho Santa Fe, CA (US)

(21) Appl. No.: 13/345,677

(22) Filed: Jan. 7, 2012

Related U.S. Application Data
(60) Provisional application No. 61/432,572, filed on Jan. 13, 2011.

(51) Int. Cl. G06Q 30/00

(52) U.S. Cl. 705/26.1

(57) ABSTRACT

A computer system forming a virtual line on a computer which includes a number of different computer users in line to receive access to a first resource on the server computer which allows users to purchase an item, and providing feedback to the computer users confirming that said computer users are still in line to purchase the item. The user can purchase the item when they reach the front of the line. The user is not allowed access to the first resource on said server computer to purchase said item prior to reaching the front position in said virtual queue. The information about position in line can be in a format that causes information on computers of said users to automatically update information indicating their place in line.

This application claims priority from provisional application No. 61/432,572, filed Jan. 13, 2011, the entire disclosure of which is herewith incorporated by reference.

### BACKGROUND

Purchasing of tickets for events often is accompanied by more demand than there are tickets. When that happens, historically, lines formed to be the first in line for the ticket agent. This “first come first serve” line gave the first tickets to the first in line.

Purchasing of tickets on the Internet is one of the most common ways of purchasing tickets. However, when an internet based ticket office opens at a certain time, the server can be overwhelmed by the large number of commands. Rather than this being first-come first serve, this becomes in essence a de facto denial of service attack against the ticket seller because so many people try to access the website at once.

Different ticket agencies have attempted different techniques, however the simple matter remains that if many thousands of people want to access the website at the same time, it becomes difficult to provide an amount of resources that can properly address the problem.

### SUMMARY

The present application recognizes that the “waiting in line” in the real world does not properly transfer to the virtual computer world. Therefore, embodiments describe one or more of the following features: a virtual line where people can actually be waiting in line on a computer system, with not all of the people waiting in line using computer resources all at the same time.

As part of this, the present system describes ways to enforce that only some number of people, defined herein by the variable A, are allowed to login and obtain computer resources at any one time.

### BRIEF DESCRIPTION OF THE DRAWINGS

The different figures show different embodiments.

FIGS. 1 and 2 show flowcharts that are carried out on a computer.

### DETAILED DESCRIPTION

The present application recognizes that a lottery system could be used to allocate tickets. However, it seems more fair to enforce a first-come, first-served basis. This in fact forms the basis of the wait-in-line system, that most people consider most fair.

One embodiment describes a system which at intervals and/or randomly requires the user respond at certain times.

The inventor recognizes a problem that websites become inoperative when they receive too many requests. Often if too many requests come in, none of them get properly served.

I recognized that a properly configured e-mail server can be used which only accepts messages a certain number at a time. For example, if an e-mail server receives 100,000 e-mails, the e-mails will eventually get through. According to one embodiment, the system chooses the time at which ticket sales will open, for example 6 AM. At exactly 6 AM according to the system clock, the system starts receiving e-mails of a specified format requesting access to the tickets. E-mails prior to the opening time may be discarded. For example, the e-mails which are received prior to the open time may be sent back with a bounce notification. In one embodiment, a website can be accessed for some period of time e.g. a month, prior to the receiving of the e-mails.

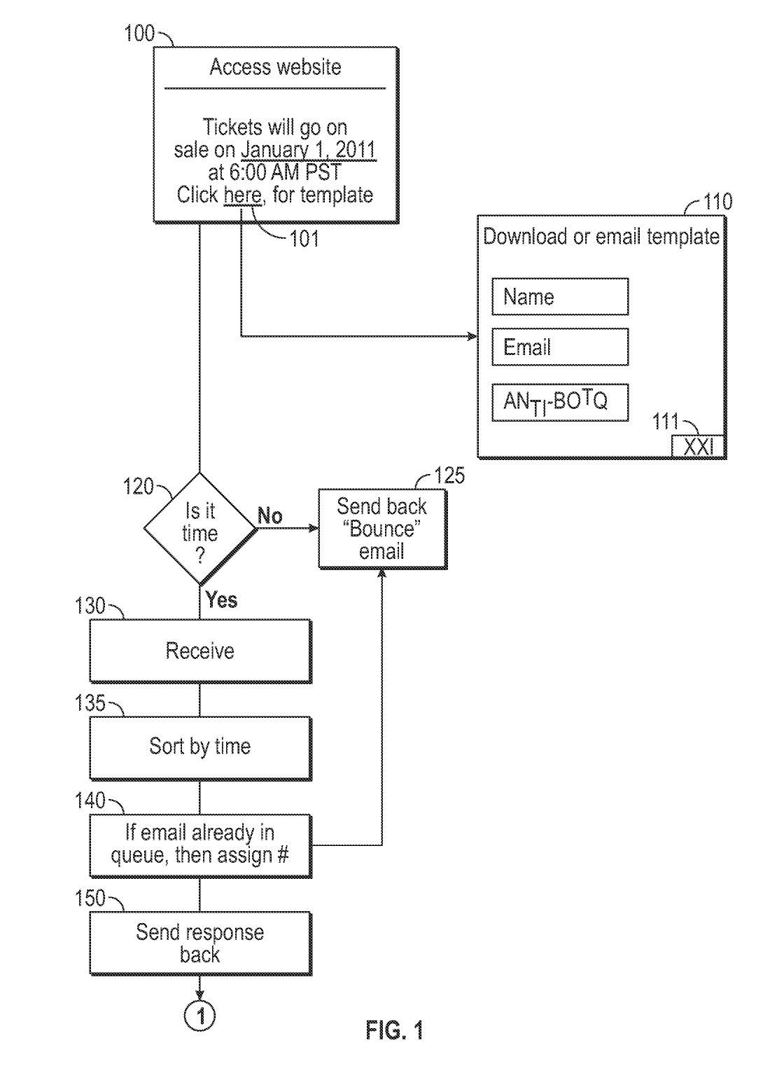

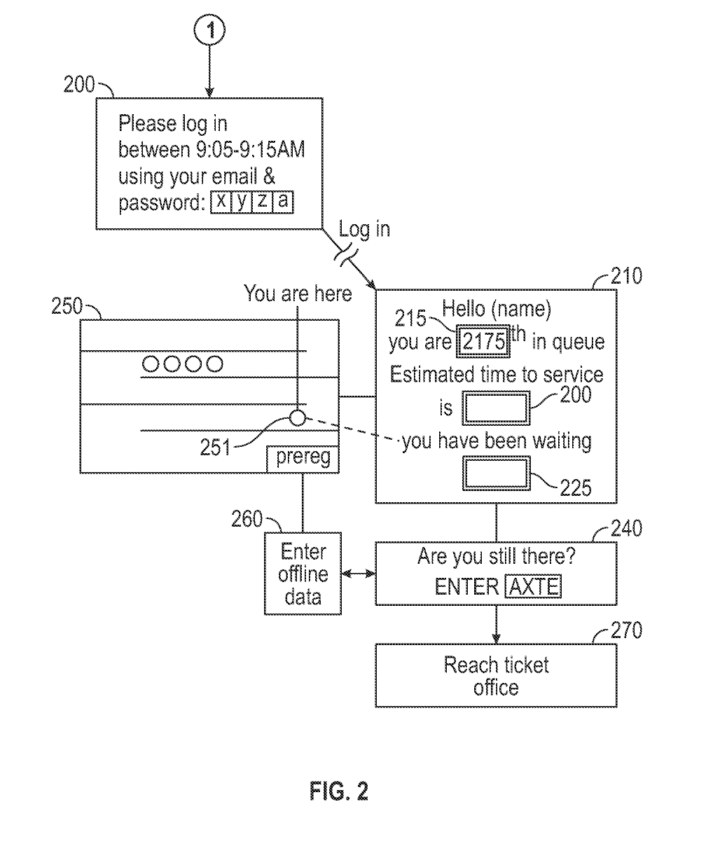

The overall operation of the obtaining of a ticket, start to finish, is shown in FIGS. 1 and 2. These show an operation of the computers that interconnect and different parts may be carried out by one or more computers. All of these activities are carried out using a suitably programmed computer.

At 100, a user accesses a website that tells about the sale.

The website indicates when the tickets will go on sale, and provides a link for a template.

The website may provide a template of the type 110 shown in FIG. 1, which allows the user to fill in certain information and send that as part of an e-mail at the specified time. The template may be pop up, or may be sent via email, or retrieved via the link 101 as shown.

The template 110 may also include a unique ID 111, so that the website can keep track of what percentage of the templates are used, and also to force the user to use an authorized template. By numbering the templates in this way, each template becomes in essence an authorized and unique form. The numbers 111 can be, for example, consecutive serial numbers, that can be maintained within a file server. According to another embodiment, the numbers 111 can be hashed values, with each of a number of different values having both a numerical portion and a hashed portion and where the hashed portion represents the results of a cryptographic operation on the numerical portion to avoid counterfeiting.

In the embodiment, the templates are sent by e-mail, so that the e-mail server receives these in order. However, different ways of getting the templates to the server can also be used. The templates can be uploaded or otherwise filled out on the website. The templates can be uploaded via FTP. However, each of these has their own possibility of possible denial of service problems. In the embodiment, the server receiving these forms preferably only receives the templates, thus lessening the load on the server.

120 shows how at the specified time, the e-mail server may receive e-mails or otherwise receives the forms and sort them by time or may receive them or take them in their received order. If messages are received prior to the appointed time, at 125, a “bounce” message is sent, e.g., from the e-mail client.

At the appointed time, the e-mail server or computer starts receiving at 130. At 135, the computer sorts the messages, putting all of the messages into a queue. 140 tests to see if the message is already in the queue, to avoid duplicates in the queue, as might otherwise happen as people send multiple emails to try and stay in the cue. This may use the return e-mail address as an identifying information. In one embodiment, the system may automatically determine if the e-mail address sending the e-mail is already in the queue, and if so, may reject the e-mail from being in the queue at 140. Any email already in the queue is bounced back at 125. This and other techniques may be used to reduce the number of duplicate entries that are in line.

At 150, the system may then send a return e-mail indicating that the request is in the queue.

During busy times, these return e-mails may be significantly delayed; especially if the number of requests being received is very high.

Other techniques may be used in order to populate the queue, for example this can be done by assigning random numbers, or by some other techniques such as lottery or the like.

The queue continues in FIG. 2 at 200, where users who have entered the queue are instructed to log in at specified times. For example, the system may tell one user to log in at some time over a time range, e.g., between 9:05 and 9:15. The login uses may tell the user to use their username, and gives a special password. Prior to sending the e-mail at 210, however, the system operates to determine and be sure that the time being given is not a time that has already passed or is likely to pass before the e-mail is completely sent. For example, the system may maintain an amount of time before the e-mail will be sent in view of the extraordinary amount of e-mail traffic, and they make sure that the time that is given is passed that. In one embodiment, for example, the login times and dates may be on a separate day from the queue formation.

The name and password becomes valid only for the specified time period. When the user logs in, they enter the queue.

Other ways can be used to form the queue. However formed, the queue is formed, causing, in FIG. 2, a number in the virtual “line”.

The user then logs in at 210, which provides the screens shown therein. At 210, the system puts the user's name in the queue and updating the place in line. This may use techniques of forming objects that are automatically updated. One of these “objects” 215 provides the user's place in line. Another object 220 provides an estimated time for service, and another 225 tells the user how long they have been waiting. By continually auto updating the objects, the user is kept apprised of their position in line, much like in a real line.

In one embodiment, the status screen 210 may be facilitated by logging the IP that is asking for service, and keeping a queue of those IP addresses. The system sends back to that IP address an object that automatically updates with status updates.

According to another embodiment shown in 250, a page may be updated which has image portions thereon, that includes an object showing a line of a conventional type (here, in zigzags) and showing the user their position in the line. 250 shows the “you are here” 251 indication, showing people in front of and behind you, and the like. In essence, this object 250 shows an image of the simulated line from above.

A user can hover over their own icon, which may be shown in color or bold or differentiated from the background in some other way. The hovering shows statistics about the place in line—for example showing that you are 480th in line, and your estimated time for wait is 900 min.

The user may be periodically queried while they are in line, to determine if they are still online and in line as shown in 240. This prevents the user from simply getting online, and then leaving their computer. Like a real line, the user needs to stay in the line. That does not mean that the user cannot be doing other things, however the user cannot simply leave the line unattended. In this embodiment, the user may be given a unique sequence of alphanumerics to type, shown in 240 as “axte”. This prevents the users from writing a program to keep them in line, and assures that essentially an observer is always in line when they are queried.

In one embodiment, the user may be allowed to switch the in-line computer. In this embodiment, the user makes a request to switch the computer 260, as they would do, for example, if they need to recharge their phone, or go into another room. The computer then returns a new registration number that can be used to login from another computer using a similar login screen to that of FIG. 2. For example, the computer may return a message saying “you can login from another computer using code X E4 DD1, along with your e-mail address and previously obtained password, so long as you do that with in the next 10 min.”

In one embodiment, the user may lose the ability to move up in line while they are transitioning between computers, that is they stay still in line and others get in front of them. This may allow, however, for the users to take breaks.

According to another embodiment, the user is allowed certain numbers of breaks per unit time.

Because the system maintains the users in a virtual line, it does not apply significant resources to any to these users. For example, the system can cycle through each of the users who are in line, and ask the users for different inputs at different times. Only during the time when the user is being asked for input or during the time when the information is being automatically updated, does the computer expend resources.

Any number of people can therefore wait in line in this way, since the system just takes longer between updates and requests, as the line gets longer.

The system may maintain an average and median time that each user takes to carry out the registration, and use that as an estimate of the time it will take the user until they are served for example. For example it may take the user an average of 10 min. or median of 11 min. until they are served. Any technique of combining these this information can be used in this way.

After the user finally does reach the front of the line at 270, however, they receive the service screen. The system may limit for example 20 people per server to having a service screen at one time, to avoid overwhelming the computers. The number of people who have certain screens can of course be changed. Whenever one person finishes their service screen, the next person is allowed into the service screen.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art.

For example other ways can be used to form a queue, that is handled according to the techniques described herein. Other kinds of virtual lines, other than for tickets, are also contemplated.

Certain kinds of computers are disclosed, but other computers, both server and client, are contemplated to be within this disclosure.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the exemplary embodiments of the invention.

The various illustrative logical blocks, modules, and circuits described in connection with the embodiments disclosed herein, may be implemented or performed with a general purpose processor, a Digital Signal Processor (DSP), an Application Specific Integrated Circuit (ASIC), a Field Programmable Gate Array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. The processor can be part of a computer system that also has a user interface port that communicates with a user interface, and which receives commands entered by a user, has at least one memory (e.g., hard drive or other comparable storage, and random access memory) that stores electronic information including a program that operates under control of the processor and with communication via the user interface port, and a video output that produces its output via any kind of video output format, e.g., VGA, DVI, HDMI, displayport, or any other form.

When operated on a computer, the computer may include a processor that operates to accept user commands, execute instructions and produce output based on those instructions. The processor is preferably connected to a communication bus. The communication bus may include a data channel for facilitating information transfer between storage and other peripheral components of the computer system. The communication bus further may provide a set of signals used for communication with the processor, including a data bus, address bus, and/or control bus.

The communication bus may comprise any standard or non-standard bus architecture such as, for example, bus architectures compliant with industry standard architecture (“ISA”), extended industry standard architecture (“EISA”), Micro Channel Architecture (“MCA”), peripheral component interconnect (“PC1”) local bus, or any old or new standard promulgated by the Institute of Electrical and Electronics Engineers (“IEEE”) including IEEE 488 general-purpose interface bus (“GPIB”), and the like.

A computer system used according to the present application preferably includes a main memory and may also include a secondary memory. The main memory provides storage of instructions and data for programs executing on the processor. The main memory is typically semiconductor-based memory such as dynamic random access memory (“DRAM”) and/or static random access memory (“SRAM”). The secondary memory may optionally include a hard disk drive and/or a solid state memory and/or removable storage drive for example an external hard drive, thumb drive, a digital versatile disc (“DVD”) drive, etc.

At least one possible storage medium is preferably a computer readable medium having stored thereon computer executable code (i.e., software) and/or data thereon in a non-transitory form. The computer software or data stored on the removable storage medium is read into the computer system as electrical communication signals.

The computer system may also include a communication interface. The communication interface allows' software and data to be transferred between computer system and external devices (e.g. printers), networks, or information sources. For example, computer software or executable code may be transferred to the computer to allow the computer to carry out the functions and operations described herein. The computer system can be a network-connected server with a communication interface. The communication interface may be a wired network card, or a Wireless, e.g., Wifi network card.

Software and data transferred via the communication interface are generally in the form of electrical communication signals.

Computer executable code (i.e., computer programs or software) are stored in the memory and/or received via communication interface and executed as received. The code can be compiled code or interpreted code or website code, or any other kind of code.

A “computer readable medium” can be any media used to provide computer executable code (e.g., software and computer programs and website pages), e.g., hard drive, USB drive or other. The software, when executed by the processor, preferably causes the processor to perform the inventive features and functions previously described herein.

A processor may also be implemented as a combination of computing devices, e.g., a combination of a DSP and a microprocessor, a plurality of microprocessors, one or more microprocessors in conjunction with a DSP core, or any other such configuration. These devices may also be used to select values for devices as described herein.

The steps of a method or algorithm described in connection with the embodiments disclosed herein may be embodied directly in hardware, in a software module executed by a processor, or in a combination of the two. A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary embodiments, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. The memory storage can also be rotating magnetic hard disk drives, optical disk drives, or flash memory based storage drives or other such solid state, magnetic, or optical storage devices. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Combinations of the above should also be included within the scope of computer-readable media. The computer readable media can be an article comprising a machine-readable non-transitory tangible medium embodying information indicative of instructions that when performed by one or more machines result in computer implemented operations comprising the actions described throughout this specification.

Operations as described herein can be carried out on or over a website. The website can be operated on a server computer, or operated locally, e.g., by being downloaded to the client computer, or operated via a server farm. The website can be accessed over a mobile phone or a PDA, or on any other client. The website can use HTML code in any form, e.g., MHTML, or XML, and via any form such as cascading style sheets (“CSS”) or other.

Also, the inventors intend that only those claims which use the words “means for” are intended to be interpreted under 35 USC 112, sixth paragraph. Moreover, no limitations from the specification are intended to be read into any claims, unless those limitations are expressly included in the claims. The computers described herein may be any kind of computer, either general purpose, or some specific purpose computer such as a workstation. The programs may be written in C, or Java, Brew or any other programming language. The programs may be resident on a storage medium, e.g., magnetic or optical, e.g. the computer hard drive, a removable disk or media such as a memory stick or SD media, or other removable medium. The programs may also be run over a network, for example, with a server or other machine sending signals to the local machine, which allows the local machine to carry out the operations described herein.

Where a specific numerical value is mentioned herein, it should be considered that the value may be increased or decreased by 20%, while still staying within the teachings of the present application, unless some different range is specifically mentioned. Where a specified logical sense is used, the opposite logical sense is also intended to be encompassed.

The previous description of the disclosed exemplary embodiments is provided to enable any person skilled in the art to make or use the present invention. Various modifications to these exemplary embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A method of forming a virtual line on a computer, comprising:
from a server computer, maintaining a virtual queue which includes a number of different computer users in line to receive access to a first resource on the server computer which allows users to purchase an item, and providing feedback to said computer users confirming that said computer users are still in line to receive said access to said first resource;
said server computer detecting when a user has reached a front position in line in the virtual queue and providing access to said first resources of the server computer to said user who has reached said front position,
and wherein said user is not allowed access to said first resource on said server computer to purchase said item prior to reaching said front position in said virtual queue.

2. A method as in claim 1, wherein said server computer sends information to multiple users indicating their place in line.

3. The method as in claim 1, wherein said server computer sends information to multiple users, and said information is in a format that causes information on computers of said users to automatically update information indicating their place in line.

4. The method as in claim 3, wherein said information includes at least both of a place in line and a time that the user has been waiting.

5. The method as in claim 3, wherein said information includes an image of a virtual line.

6. The method as in claim 3, further comprising, from the server computer, prompting the user to confirm that the user is near the user computer and maintaining the user's place in line only when the user confirms that they are near the user computer.

7. The method as in claim 6, wherein said prompting comprises requesting the user to enter information from the user computer, and verifying that information, and maintaining the persons place in line only when said verifying.

8. The method as in claim 1, wherein said item is a ticket to be purchased.

9. A method of forming a virtual line on a computer, comprising:
on a client computer, viewing a position in a virtual queue which includes a computer user, and a number of other computer users in said virtual queue to receive access to a first resource which allows users to purchase an item;
said viewing said position comprising viewing said position in line;
obtaining access to said first resource from the client computer which allows users to purchase an item only when a user has reached a front position in line in the virtual queue and allowing the user has reached a front position in line to purchase said item, all users who have not reached the front position in line are not allowed access to said first resource and not allowed to purchase said item.

10. The method as in claim 9, wherein said client computer displays information to the user which is automatically updated indicating their place in line relative to multiple other users.

11. A method as in claim 9, wherein said client computer displays information to the user indicating at least both of a place in line and a time that the user has been waiting.

12. A method as in claim 9, wherein said client computer displays said information to the user including an image of a virtual line.

13. The method as in claim 3, wherein said client computer prompts the user to confirm that the user is near the user computer wherein the user's place in line is maintained only when the user confirms that they are near the user computer.

14. The method as in claim 13, wherein said prompts comprises requesting the user to enter information from the user computer, and verifying that information, and maintaining the person's place in line only based on said verifying.

15. The method as in claim 9, wherein said item is a ticket to be purchased.

16. A computer system forming a virtual line on a computer, comprising:
a server computer, maintaining a virtual queue which includes a number of different computer users in line to receive access to a first resource on the server computer which allows users to purchase an item,
said server computer providing feedback to said computer users confirming that said computer users are still in line to receive said access to said first resource;
said server computer detecting when a user has reached a front position in line in the virtual queue and providing access to said first resources of the server computer to said user who has reached said front position,
and wherein said server computer does not allow said user access to said first resource on said server computer to purchase said item prior to reaching said front position in said virtual queue.

17. The computer system as in claim 16, wherein said server computer sends information to multiple users, and said information is in a format that causes information on computers of said users to automatically update information indicating their place in line.

18. The computer system as in claim 17, wherein said information includes at least both of a place in line and a time that the user has been waiting.

19. The computer system as in claim 18, wherein said information includes an image of a virtual line.

20. The computer system as in claim 19, further comprising, from the server computer, prompting the user to confirm that the user is near the user computer and maintaining the user's place in line only when the user confirms that they are near the user computer, wherein said prompting comprises requesting the user to enter information from the user computer, and verifying that information, and maintaining the persons place in line only when said verifying.
